(19) United States
(12) Patent Application Publication
(10) Pub. No.: US 2006/0088384 A1
(43) Pub. Date: Apr. 27, 2006

(54) Stored energy coupling and pipe bursting apparatus

(76) Inventor: Samuel W. Putnam, West Monroe, LA (US)

Correspondence Address: John M. Harrison, 2139 E. Bert Kouns, Shreveport, LA, 71105, US

(21) Appl. No.: 11/254,197

(22) Filed: Oct. 19, 2005

Related U.S. Application Data
(60) Provisional application No. 60/621,149, filed on Oct. 22, 2004.

(51) Int. Cl. F16L 55/18

(52) U.S. Cl. 405/184.1; 405/184.3

(57) ABSTRACT

A stored energy coupling and pipe bursting apparatus which is designed to increase the efficiency of pipe-bursting by enhancing the effect of a pneumatic or hydraulic hammer used while moving the pipe-bursting head. In one embodiment the stored energy coupling has one or more internal springs and operates to improve the energy output of a hammer as the pipe-bursting head traverses the length of the pipe to be broken responsive to the pulling action of a single hydraulic cylinder having dual rod or cable gripping elements. In another embodiment the stored energy coupling has no spring and is designed to prevent damage to the static pulling device when the hammer is implemented. The stored energy coupling of this invention can be installed in front or behind the bursting head, or even in the bursting head and is always positioned in front of the hammer. The stored energy coupling can also be utilized in a common housing with the hammer and with a cable or rod pulling apparatus of any design, including a hydraulic cylinder which uses a rod or cable connection and dual gripping elements for immobilizing the rod or cable between pulling sequences.

### CROSS-REFERENCE TO RELATED APPLICATIONS

This application claims the benefit of and incorporates by reference prior filed copending U.S. Provisional Application Ser. No. 60/621,149, Filed Oct. 22, 2004.

### BACKGROUND OF THE INVENTION

This invention relates to pneumatic percussion hammers and added efficiency thereof when the hammers are used with stored energy systems. These pneumatic hammers have been used primarily for pipe bursting, pipe ramming and percussion boring and in the pipe bursting industry, winches are typically used to pull or guide the hammers along preselected paths. Eight to twenty (8-20) ton static pull winches are normally used for this purpose.

Unless a continuous pull system having a combination of two cylinders or four cylinders is used as the pulling apparatus in pipe bursting operations, the pipe being pulled will have a pull resistance due to friction that must be considered. The friction of the soil on the pipe increases the pulling requirements which, in turn, causes the typically high density polyethylene (HDPE) pipe to stretch. Stretching of the pipe is not critical until the total stretch becomes more than about 5 percent, which amounts to 5 linear feet of stretch in 100 linear feet of HDPE pipe. Accordingly, the pulling cylinder must overcome the drag of the pipe, which frictional resistance is determined by a factor times the weight of the pipe being pulled. It must also overcome the resistance of the bursting head as it is being pulled through the various types of soil, pipe and pipe structures such as valves, opening a hole for the new pipe. The hole in the earth made by the bursting head closes around the pipe at varying intervals, causing a frictional load that needs to be monitored and controlled. This control is accomplished according to this invention by using a washer-shaped strain gauge-based load cell which measures only the resistance which causes the stretching of the HDPE pipe. The load cell has a gauge for measuring the resistance causing stretch in the HDPE pipe and since the operator constantly monitors the gauge, the pulling operation can be adjusted or terminated before any damage is done to the pipe.

### SUMMARY OF THE INVENTION

Stored energy couplings are designed to increase the efficiency of hammers, both pneumatic and hydraulic, used in connection with pipe-bursting apparatus. The stored energy couplings of this invention can be installed in front of the bursting head, behind the bursting head or in the bursting head and are always located in front of the hammer. The stored energy couplings can also be located in a common housing or container with the hammer. In a preferred embodiment the stored energy couplings are each characterized by a cylinder containing one or more springs and connected to the bursting head and the hammer in such a way as to improve the efficiency of the hammer during the pipe-bursting procedure. The stored energy couplings can also be used without a spring or springs to isolate the hammer from the typically hydraulic static pull machine and thus prevent damage to the pulling apparatus due to repetitive hammer strikes on the bursting head apparatus. Under these circumstances the coupling has no stored energy capacity but will eliminate the destruction of the static pull machine where this is the only concern in the operating device. The combination of the stored energy coupling without a spring and the hammer allows the user to use both the hammer and the static pull machine at the same time, thus combining the force and energy of the hammer to a lesser degree than under circumstances where the stored energy coupling incorporates one or more springs for optimizing energy application to the bursting head.

The stored energy couplings and hydraulic cylinder pulling apparatus of this invention serve to render pneumatic and hydraulic hammers more efficient, since they allow every stroke of the hammer to expend additional energy against the pipe to be burst. Under circumstances where the stored energy couplings include one or more springs, the compression of these springs stores energy. When tension in the spring or springs is released, energy is instantly transferred from the springs against the pipe-bursting head, along with the pulling apparatus tension to facilitate a more efficient splitting or bursting of the pipe in question. Stored energy couplings used with conventional winches must include a spring or springs which the winch is capable of compressing. For example, if a ten-ton winch is used as a pulling apparatus, then a stored energy coupling must include at least one spring that will compress using not over 20,000 pounds of pull. A spring that fully compresses at 35,737 pounds will compress one inch when a force of 6,462 pounds is applied by the pulling apparatus. This spring will be fully compressed when it travels approximately 5.5 inches and the resulting compression rate is measured in pounds per inch of compression in the spring.

Accordingly, under circumstances where static pull machines such as hydraulic cylinders and winches are utilized with cables or rods to pull a pipe bursting head through a pipe to be burst or split, the stored energy couplings of this invention facilitate the use of a pneumatic or hydraulic hammer with a static pull machine to increase the energy applied to the pipe to be burst, thus facilitating a greater pulling or driving power capacity in the static pull machine or device. Consequently, larger pipe can be pulled and split with smaller static pull machines using this expedient. In the use of static pull machines to operate the pipe-bursting head, the chosen stored energy coupling must have space between the spring or springs and the end plate for compressing the spring or springs located in the device. This space allows the spring or springs to decompress and release energy beyond the point of compression and facilitates operation of the pneumatic hammer without damaging the static pull mechanism. The use of a hydraulic cylinder of unique design, coupled with a pair of highly efficient gripping elements and the stored energy couplings of this invention facilitates optimum efficiency in the pipe busting operation.

### BRIEF DESCRIPTION OF THE DRAWINGS

The invention will be better understood by reference to the accompanying drawings, wherein:

FIG. 1 is a perspective view of a typical pipe-bursting head apparatus of this invention fitted with pipe cutting blades and a hammer for pulling pipe which replaces a pipe to be burst using a conventional static pull winch drum;

FIG. 2 is a longitudinal sectional view of the pipe-bursting head apparatus illustrated in FIG. 1, with a dual spring stored energy coupling therein;

FIG. 3 is an exploded view of the pipe-bursting apparatus illustrated in FIG. 2;

FIG. 4 is a longitudinal sectional view of a typical stored energy coupling of this invention which has no internal spring and is used to prevent damage to a pulling apparatus under circumstances where a hammer is used in a pipe-bursting apparatus to intensify the energy expended on a pipe to be broken;

FIG. 4.1 is a longitudinal sectional view of the springless stored energy coupling illustrated in FIG. 4, more particularly illustrating a bursting head and hammer positioned behind the stored energy coupling and a pull cable attached to the front end of the stored energy coupling for attachment to a pulling machine, typically a hydraulic cylinder (not illustrated);

FIG. 5 is a longitudinal sectional view of a stored energy coupling of this invention having a pair of relaxed springs therein attached to a pull rod, with a hammer fitted to the rear end of the coupling for applying a repetitive force on the coupling to enhance the efficiency of a pipe-bursting apparatus (not illustrated), typically connected to the stored energy coupling forwardly of the hammer and coupling;

FIG. 6 is a longitudinal sectional view of the stored energy coupling illustrated in FIG. 5, more particularly illustrating a tensile force applied to the pull rod by a pulling apparatus (not illustrated) for compressing the second spring located internally of the stored energy coupling;

FIG. 7 is a longitudinal sectional view of the stored energy coupling illustrated in FIGS. 5 and 6, including a pipe-bursting head mounted on the front end thereof and fitted with a hammer at the rear end thereof, with both of the internal springs compressed prior to operation of the hammer;

FIG. 8 is a longitudinal sectional view of a stored energy coupling of this invention having three internal springs, with a pull cable extending from the front of the coupling and a pipe-bursting head located rearwardly of the coupling and attached to the coupling by means of a coupling mechanism and including a hammer located inside the pipe bursting head for enhancing the efficiency of the pipe-bursting head;

FIG. 9 is a sectional view of another embodiment of the stored energy coupling of this invention, more particularly illustrating a single spring element in a common housing with a pneumatic hammer for enhancing the progress of a bursting head through a pipe to be burst responsive to application of a pulling device such as the hydraulic cylinder and dual gripping elements (not illustrated) of this invention;

FIG. 9A is a sectional view taken along line 9A-9A of the bursting head element illustrated in FIG. 9;

FIG. 10 is a perspective view of a preferred embodiment of a hydraulic cylinder and dual, aligned gripping elements mounted on the hydraulic cylinder and in the cylinder frame and used in cooperation with the stored energy couplings (not illustrated) of this invention;

FIG. 11 is a top view of the hydraulic cylinder, dual gripping elements and frame combination illustrated in FIG. 10;

FIG. 12 is a longitudinal sectional view of the hydraulic cylinder and the cylinder gripping element taken along line 12-12 in FIG. 11;

FIG. 13 is a rear end view of the mounted hydraulic cylinder taken along line 13-13, illustrated in FIG. 11;

FIG. 14 is a sectional view of a preferred frame gripping element for use in connection with the hydraulic cylinder and taken along line 14-14 illustrated in FIG. 11;

FIG. 15 is a rear view, partially in section, of the rear end of the frame gripping element illustrated in FIG. 14; and

FIG. 16 is a front view, partially in section, of the front end of the frame gripping element illustrated in FIG. 14.

### DESCRIPTION OF THE PREFERRED EMBODIMENTS

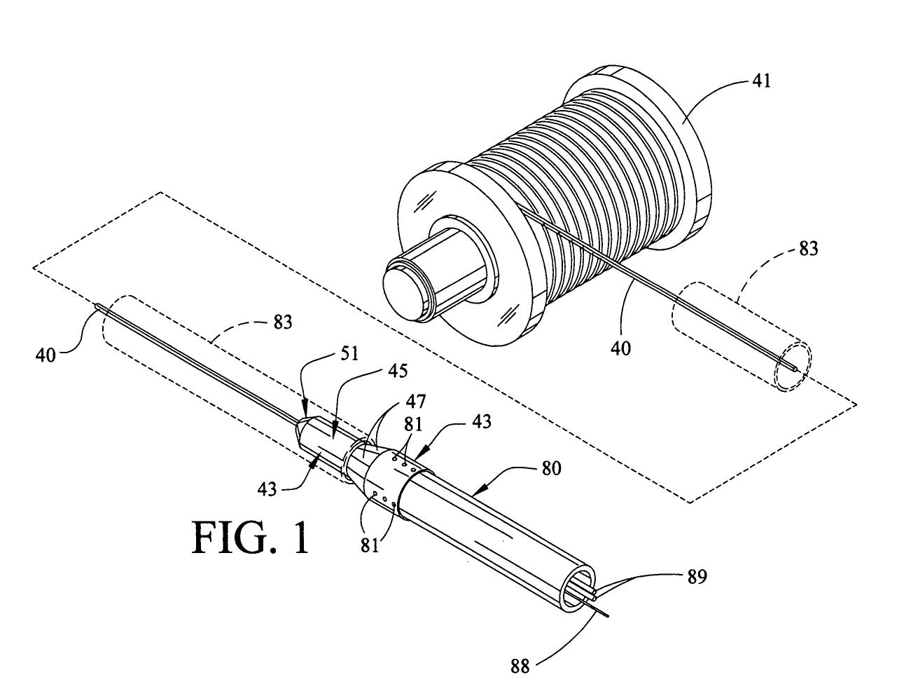

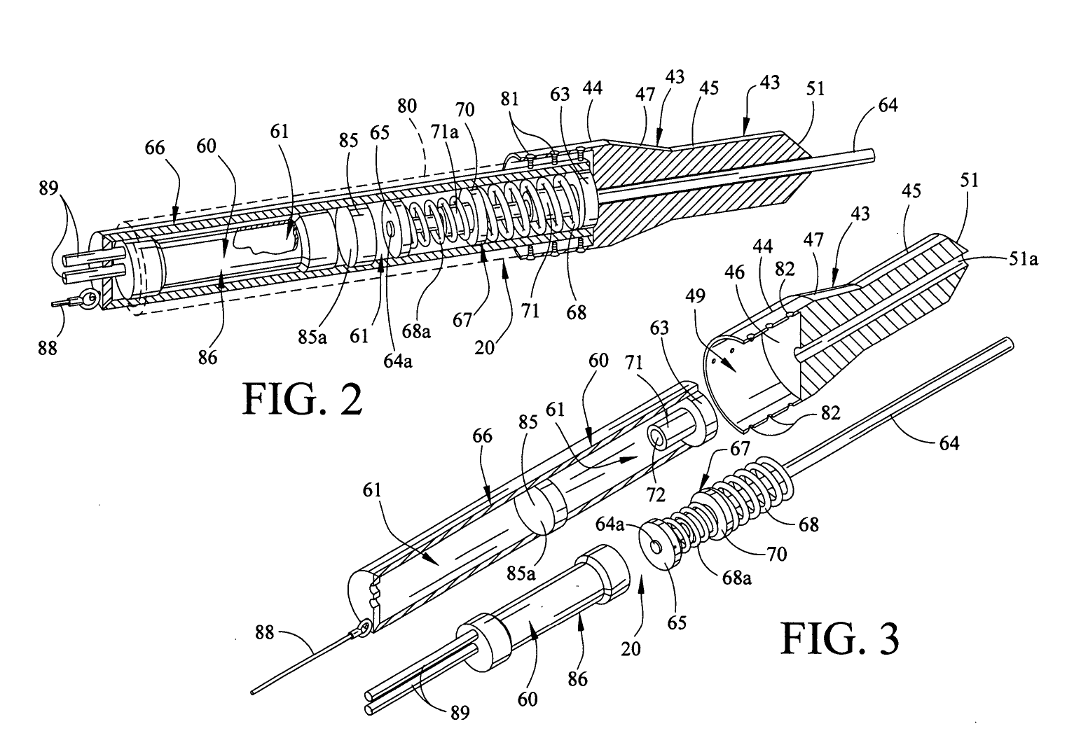

Referring initially to FIGS. 1-3 of the drawings, a bursting head containing a stored energy coupling of this invention is generally illustrated by reference numeral 43 and is characterized by multiple pipe cutting blades 47 that extend to a nose 45. A replacement pipe 80 (illustrated in phantom) is secured to the rear portion or expander 44 of the bursting head 43, typically by means of pipe screws 81, and a pull cable spool 41 of a conventional static pull machine (not illustrated) contains a supply of pull cable 40 wound thereon, with the extending free end of the pull cable 40 attached to the bursting head 43, typically at a pull rod 64, as illustrated in FIGS. 2 and 3. Included within the length of replacement pipe 80 attached to the bursting head 43, is a cylindrical spring assembly and hammer container or housing 66 having a container interior 61, fitted with a dual spring stored energy coupling 20, which includes an energy coupling spring assembly 67 and further including a hammer 86, as further illustrated in FIGS. 2 and 3. The bursting head 43 is aligned with a pipe to be broken, generally illustrated by reference numeral 83 and shown in phantom (FIG. 1) for bursting the pipe 83 responsive to tension applied to the pull cable 40 by a winch or other static pulling mechanism (not illustrated), typically connected to and driving the pull cable spool 41 (FIG. 1).

As further illustrated in FIGS. 2 and 3 of the drawings, the pull rod 64 extends through a longitudinal cap opening 51a provided in the nose cap 51 of the nose 45 and terminates in the container interior 61 at a rod plate 65, to which the pull rod 64 is welded or otherwise attached at a pull rod end 64a. A nose plate 63 is welded or otherwise secured to the front end of the spring assembly and hammer housing 66 and the energy coupling spring assembly 67 is disposed inside the front portion of the spring assembly and hammer housing 66, forwardly of a receiver or striker plate 85, typically welded in the spring assembly and hammer housing 66, as further illustrated in FIGS. 2 and 3. A sliding spring plate 70 is mounted on a sliding second spring stop 71a and is interposed between the nose plate 63 and the rod plate 65 in the spring assembly and hammer housing 66, forwardly of the fixed striker plate 85. A first spring 68 of the energy coupling spring assembly 67 is further interposed between the nose plate 63 and the spring plate 70 on the pull rod 64 and is deployed around a fixed first spring stop 71, which fits between the coils of the first spring 68 and is typically fixed to the nose plate 63, to limit compression of the first spring 68 responsive to tension applied to the pull rod 64, typically by a hydraulic cylinder pulling apparatus, hereinafter described. Similarly, a second spring 68a is interposed between the sliding spring plate 70 and the rod plate 65 and is deployed around the second spring stop 71a (FIG. 2), typically fixed to the spring plate 70, for the same purpose. Accordingly, as further illustrated in FIGS. 1-3 of the drawings, tension applied to the pull rod 64 and pull cable 40 by a static pull device (not illustrated) coupled to the pull cable spool 41 or a pulling apparatus such as the hydraulic cylinder and gripping element hereinafter described, compresses the second spring 68a and the first spring 68 in sequence until the rod plate 65 approaches the second spring stop 71a and the spring plate 70 approaches the first spring stop 71 in the energy coupling spring assembly 67, for purposes which will be hereinafter further described.

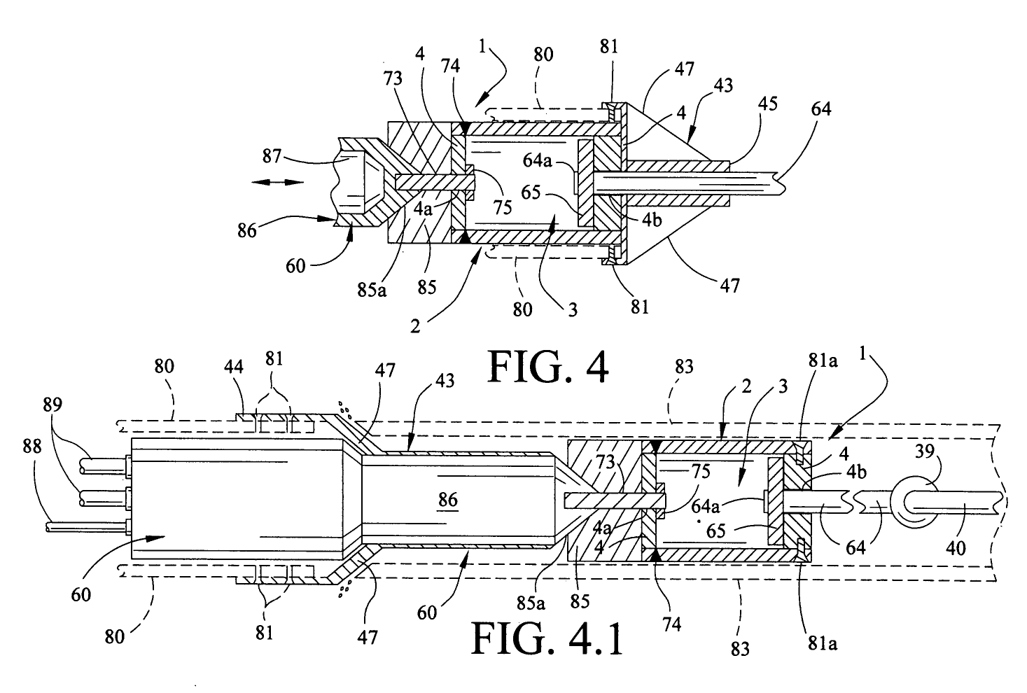

The hammer 86 is typically deployed inside the spring assembly and hammer housing 66 rearwardly of the fixed striker plate 85 and includes a hammer housing 60, fitted with a conventional internal hammer striker (not illustrated) designed to repetitively strike the striker plate seat 85a of the striker plate 85, for purposes which will be hereinafter further described. The hammer 86 may be operated by air or hydraulic fluid, according to the knowledge of those skilled in the art and typically includes a pair of hammer-operating hoses 89 that extend through the hammer housing 60 for causing the hammer striker 87 (see FIG. 4) to repetitively strike the striker plate seat 85a of the striker plate 85. Furthermore, a hammer cable 88 is attached to the spring assembly and hammer container 66 for removing the entire bursting head 43 and the companion spring assembly and hammer housing 66 from contact with the pipe 83, should this become necessary in the course of operation.

Accordingly, it will be appreciated by those skilled in the art that the spring assembly and hammer housing 66 contains a combination dual spring stored energy coupling 20, which includes an energy coupling spring assembly 67, along with a hammer 86, for coupling to either a conventional or specially designed bursting head 43 and effecting greater efficiency in forcing the bursting head 43 through a pipe 83 and typically pulling a replacement pipe 80 in place. Operation of the self-contained dual spring stored energy coupling 20 and hammer 86 in combination with a specially designed hydraulic cylinder and gripping element to achieve this objective is hereinafter further described.

Referring now to FIGS. 4 and 4.1 of the drawings, in another preferred embodiment of the invention a cylindrical springless stored energy coupling is generally illustrated by reference numeral 1 and includes a coupling housing 2 having a coupling housing interior 3. In a preferred embodiment the rear end of the cylindrical coupling housing 2 is closed by a housing end plate 4, typically fixed in place by means of a weld 74 and the forward end of the coupling housing 2 is closed by means of a second housing end plate 4, typically removably maintained in place by means of end plate mount screws 81a, as illustrated in FIG. 4.1. Accordingly, the coupling housing interior 3 of the springless stored energy coupling 1 can be accessed by removing the respective end plate mount screws 81a and the forward housing end plate 4. This access is necessary in order to secure the threaded end of a bolt 73 that extends through an end plate opening 4a in the rear housing end plate 4 and through an opening (not illustrated) in the striker plate 85, by means of a nut 75, as illustrated in FIGS. 4 and 4.1. The bolt 73 is welded or otherwise attached to the hammer housing 60 and is designed to mount the hammer housing 60 of a hammer 86 to the rear end of the springless stored energy coupling 1 at the striker plate 85, as further illustrated in FIGS. 4 and 4.1 of the drawings. A reciprocating hammer striker 87 (FIG. 4) reciprocates inside the hammer housing 60 and is designed to repetitively strike the frontal portion of the internal cavity in the hammer housing 60, which is seated in a conical recess or plate seat 85a in the striker plate 85, as further hereinafter described. A bursting head 43, having pipe cutting blades 47, is typically mounted on the front end of the springless stored energy coupling 1 (FIG. 4) or rearwardly of the hammer 86 (FIG. 4.1) and the combination springless stored energy coupling 1 and hammer 86 is pulled by operation of a pull rod 64 (or a cable such as the pull cable 40, illustrated in FIGS. 1 and 4.1) that extends through the bursting head 43 and the front end plate opening 4b of the housing end plate 4 and terminates at one end of the rod plate 65.

Referring again to FIG. 4.1 of the drawings, the bursting head 43 is located rearwardly of the springless stored energy coupling 1 and the internal hammer 86 has a hammer housing 60 that is attached to the rear housing end plate 4 of the springless stored energy coupling 1 in the same manner as illustrated in FIG. 4 of the drawings. Accordingly, in operation, the springless stored energy coupling 1 illustrated in FIGS. 4 and 4.1 operates to insulate a static pulling apparatus such as a conventional winch or the like or a hydraulic cylinder and gripping element as hereinafter described, from the effects of the repetitive pounding of the hammer striker 87 inside the hammer housing 60 at the striker plate 85 due to the design of the coupling housing interior 3. In both FIGS. 4 and 4.1 the rod plate 65 is illustrated as seated against the forward housing end plate 4 and spaced-apart from the bolt 73 and nut 75. As in the case of the dual spring stored energy coupling 20, fitted with the combined energy coupling spring assembly 67 and hammer 86 illustrated in FIGS. 1-3 of the drawings, the pull rod 64, connected to the rod plate 65, is typically designed to attach to a pull cable 40 (or a pull rod 64) which is connected to a pulling apparatus (not illustrated) for pulling the springless stored energy coupling 1, the hammer 86 and the bursting head 43 through a pipe 83 (illustrated in phantom in FIG. 4.1) to be burst. Further as in the case of the bursting head 43 illustrated in FIGS. 2 and 3 of the drawings, a replacement pipe 80 (also illustrated in phantom in FIG. 4.1) may be pulled in place, replacing the burst pipe 83.

Accordingly, it will be appreciated from a consideration of FIGS. 1, 4 and 4.1 of the drawings that the dual spring stored energy coupling 20 illustrated in FIG. 2 is fitted with a bursting head 43 located forwardly on the spring assembly and hammer housing 66, whereas the springless stored energy coupling 1 illustrated in FIG. 4.1 includes a bursting head 43 that is positioned behind the coupling housing 2. It is significant that the springless stored energy coupling 1 illustrated in FIGS. 4 and 4.1 can therefore be located at any point forwardly or behind the bursting head 43, but always forwardly of the companion hammer 86.

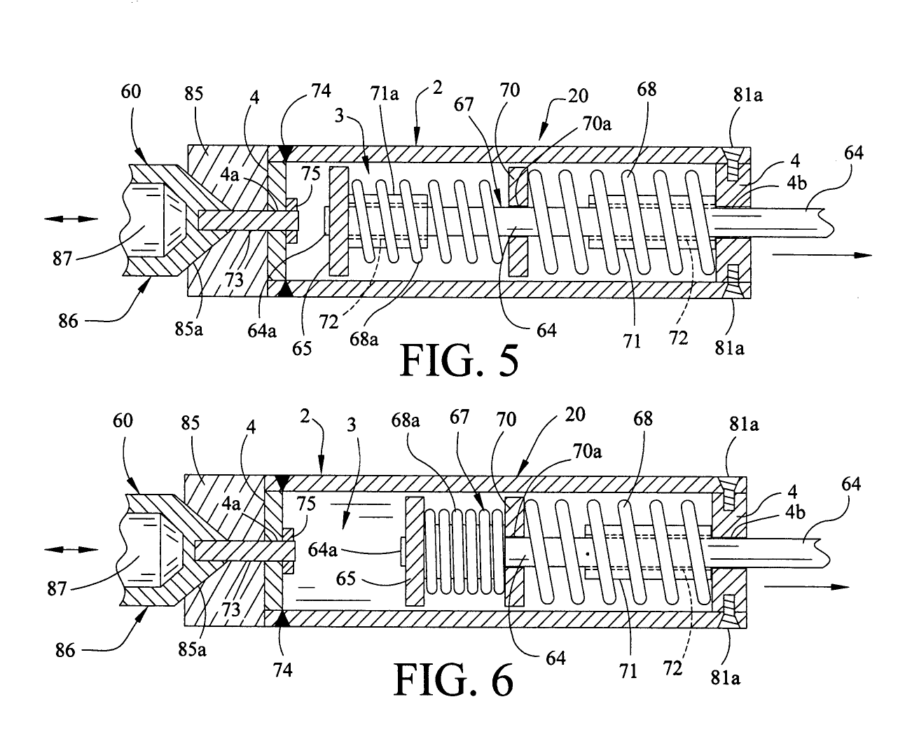

Referring to FIGS. 5 and 6 of the drawings, whereas the springless stored energy coupling 1 illustrated in FIGS. 4 and 4.1 has no internal spring assembly, the modified dual spring stored energy coupling 20 illustrated in FIGS. 5 and 6 contains an energy coupling spring assembly 67 characterized by a pair of springs designated as a first spring 68 and a second spring 68a. The dual spring stored energy coupling 20 is similar in design to the dual spring stored energy coupling 20 illustrated in FIGS. 2 and 3, except for the fitting of the second spring stop 71a on the rod plate 65 and the design of the hammer 86. In FIG. 5, a load has not yet been applied to the pull rod 64, extending through the front end plate opening 4b, the spring stop bores 72 and the spring plate opening 70a in the spring plate 70 and both the first spring 68 and the typically less powerful second spring 68a, are relaxed. Furthermore, the hammer 86 is attached to the fixed rear housing end plate 4 at a striker plate 85 in the same manner as that illustrated in FIGS. 4 and 4.1, typically by means of a bolt 73 and a corresponding nut 75. An internal hammer striker 87 is therefore designed to reciprocate inside the hammer housing 60 and apply a repetitive, forward-directed force to the dual spring stored energy coupling 20, which force compliments the released energy in the first spring 68 and the second spring 68a elements of the energy coupling spring assembly 67, to operate a bursting head (not illustrated) with improved efficiency, as hereinafter further described.

As further illustrated in FIG. 6 of the drawings, a tensile load is applied to the pull rod 64, causing complete compression of the second spring 68a. Additional tension applied to the pull rod 64 will also tension and compress the first spring 68, as a pulling force is applied to the pull rod 64 by means of a winch or other pulling mechanism (not illustrated). It will be appreciated by those skilled in the art that, as in the case of the springless stored energy coupling 1 illustrated in FIGS. 4 and 4.1 of the drawings, a bursting head (not illustrated) can be attached to the dual spring stored energy coupling 20 illustrated in FIGS. 5 and 6, either forwardly of the coupling housing 2 (FIG. 4) or rearwardly of the coupling housing 2 (FIG. 4.1), as hereinafter described. In the latter case, the bursting head 43 may be installed as illustrated in FIG. 4.1 with the hammer 86 deployed therein. Operation of the dual spring stored energy coupling 20 illustrated in FIGS. 5 and 6 and the stored energy couplings in other embodiments of the invention will be hereinafter further described, wherein the cooperation between the first spring 68 and second spring 68a, as well as a later described third spring, in expending energy to force the bursting head forwardly in combination with operation of the hammer 86 is described.

Referring now to FIG. 7 of the drawings, the dual spring stored energy coupling 20 illustrated in FIGS. 5 and 6 of the drawings is provided with a bursting head 43 that is secured to the removable front housing end plate 4 and is fitted with multiple pipe cutting blades 47 for splitting a pipe 83, as illustrated in FIGS. 1, 2 and 3 of the drawings. A hammer 86 is attached to the fixed rear housing end plate 4 at a striker 85 in the same manner as described above with respect to FIGS. 4, 4.1, 5 and 6 of the drawings, with the reciprocating hammer striker 87 provided inside a hammer housing 60 for repetitively striking the front portion of the inside of the hammer housing 60 and augmenting the energy stored in the first spring 68 and second spring 68a, to increase the efficiency of the bursting head 43 and bursting the pipe 83, as hereinafter further described. Further as in the case of the stored energy couplings illustrated in FIGS. 4, 4.1, 5 and 6 of the drawings, sufficient space is provided in the coupling housing interior 3 between the rod plate 65 and the nut 75 on the extending threaded end of the bolt 73, to compensate for momentary reverse movement of the pull rod 64 and rod plate 65 responsive to striking of the hammer striker 87 against the inside frontal surface of the hammer housing 60 during the pipe bursting operation.

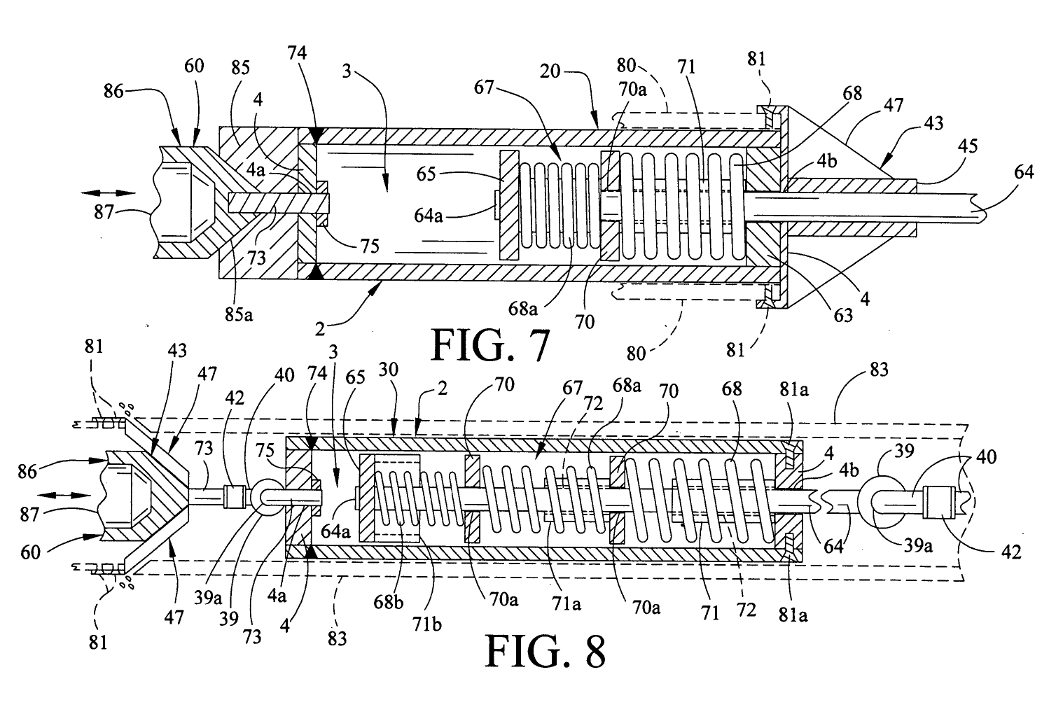

Referring again to FIG. 7 and initially to FIG. 8 of the drawings, in another preferred embodiment of the invention a tri-spring stored energy coupling 30 (FIG. 8) is characterized by a coupling housing 2 having a coupling housing interior 3 fitted with an energy coupling spring assembly 67 consisting of three springs. Accordingly, a first spring 68, second spring 68a and a third spring 68b are provided inside the coupling housing interior 3, between a removable front housing end plate 4 and a fixed rear housing end plate 4. A pair of the sliding spring plates 70 are spaced-apart on that portion of the pull rod 64, which extends through the respective spring plate openings 70a and is positioned inside the coupling housing 2 to accommodate the second spring 68a. Furthermore, the respective first, second and third spring stops 71, 71a and 71b, located in cooperation with the housing end plate 4, spring plates 70 and rod plate 65 and the first spring 68, second spring 68a and third spring 68b, respectively, as heretofore described, serve to insure that the first spring 68, second spring 68a and third spring 68b do not over-compress responsive to a tensile load applied to the pull rod 64 (FIG. 7) and the pull cable 40 (FIG. 8). In a preferred embodiment the pull cable 40 is typically attached to the pull rod 64 at the front of the tri-spring stored energy coupling 30 by means of a clevis 39, wherein the pull cable 40 is extended through the clevis eye 39a of the clevis 39, as further illustrated in FIG. 8. Similarly, also as illustrated in FIG. 8, the bolt 73 may be shaped to extend through the corresponding clevis eye 39a of a second clevis 39 for attachment to a second bolt 73 at a clamp 42. The opposite end of the second bolt 73 is typically threaded into or otherwise secured to the hammer housing 60 of a hammer 86, typically in the same or a similar manner as illustrated in FIG. 7 and in other embodiments illustrated in the drawings.

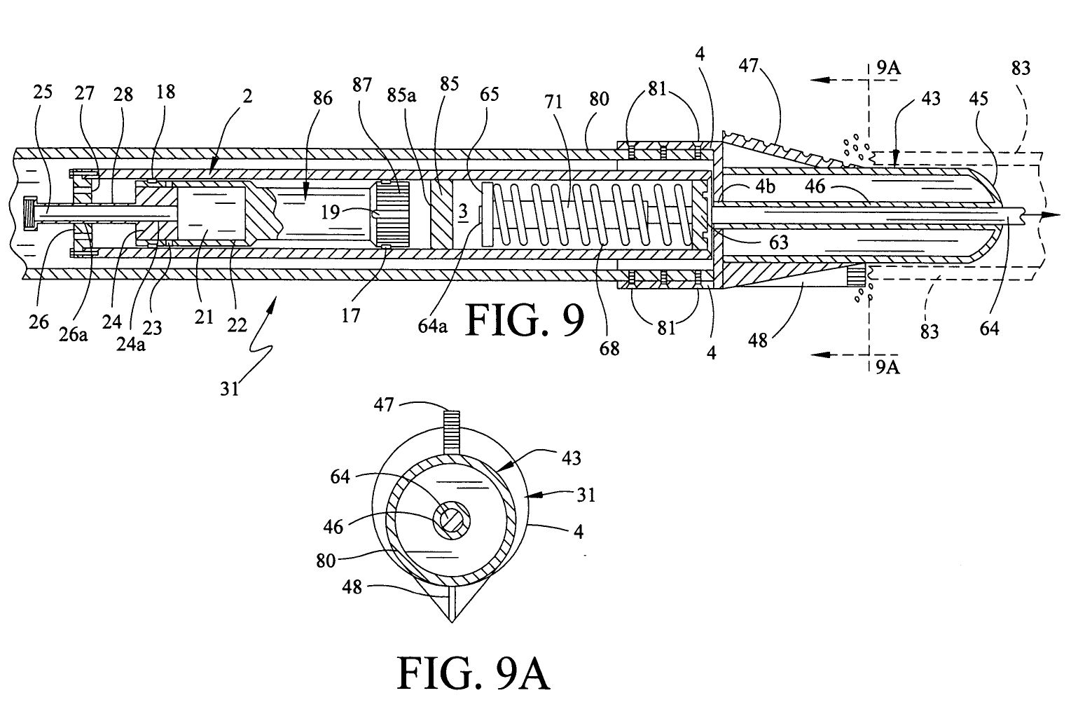

Referring now to FIGS. 9 and 9a of the drawings, in another preferred embodiment of the invention a single-spring stored energy coupling 31 is incorporated in a cylindrical coupling housing 2 having a coupling housing interior 3, fitted with a striker plate 85 having a plate seat 85a. A replacement pipe 80 fits over the coupling housing 2 and is typically attached to the housing end plate 4 of the coupling housing 2 by pipe screws 81. The pull rod 64 extends through a rod sleeve 46 provided inside the bursting head 43 at the nose 45, which also extends through the front end plate opening 4b in the housing end plate 4, as further illustrated in FIG. 9. The bursting head 43 is also illustrated in position to burst a pipe 83 (illustrated in phantom) by operation of the respective pipe cutting blades 47 provided on the bursting head 43. In a preferred embodiment a bottom cutting blade 48 is provided on the bottom of the bursting head 43 and is flared or bevelled as illustrated in FIG. 9A, for additional efficiency in splitting the pipe 83. The pull rod 64 further extends through a central opening (not illustrated) in a nose plate 63, mounted in the forward end of the coupling housing 2 and also through a first spring 68 and a spring stop bore (not illustrated) in a first spring stop 71, as heretofore described. The pull rod 64 terminates at a pull rod end 64a, which carries the first spring stop 71 and is welded or otherwise attached to a rod plate 65 in the coupling housing interior 3, as further illustrated in FIG. 9. Accordingly, tension applied to the pull rod 64 or to a cable (not illustrated) attached to the pull rod 64 in the direction of the arrow illustrated in FIG. 9 compresses the first spring 68 and operates the single-spring stored energy coupling 31 to force the bursting head 43 through the pipe 83. As further illustrated in FIG. 9 of the drawings, a typical hammer 86 is disposed inside the coupling housing interior 3 of the coupling housing 2 and includes a hammer striker 87, typically fitted with axial grooves 19. The hammer striker 87 is designed to reciprocate inside the coupling housing 2 and is driven by a control piston 24, seated in a piston sleeve 22 and having a cylinder chamber 21. The piston sleeve 22 is further typically fitted with control ports 23 and air is supplied to the cylinder chamber 21 of the control piston 24 through the duct 25 in a compressed air hose 28 and the control piston bore 24a, for handling compressed air supplied to the control piston 24 from a source (not illustrated). A clamp 26 is fitted on the coupling housing 2 and is designed to immobilize the compressed air hose 28 as it extends from the coupling housing 2 inside the replacement pipe 80.

As further illustrated in FIG. 9, front slide rings 17 are typically provided in the hammer striker 87 and rear slide rings 18 may be disposed in the piston sleeve 22 for guiding and sealing the control piston 24 and the corresponding hammer striker 87 inside the coupling housing 2. Furthermore, axial passages 27 are typically provided in the clamp 26 to facilitate return of air from the interior of the coupling housing 2, responsive to reverse-movement of the control piston 24 after each striking of the plate seat 85a on the striker plate 85 by the hammer striker 87, as hereinafter further described.

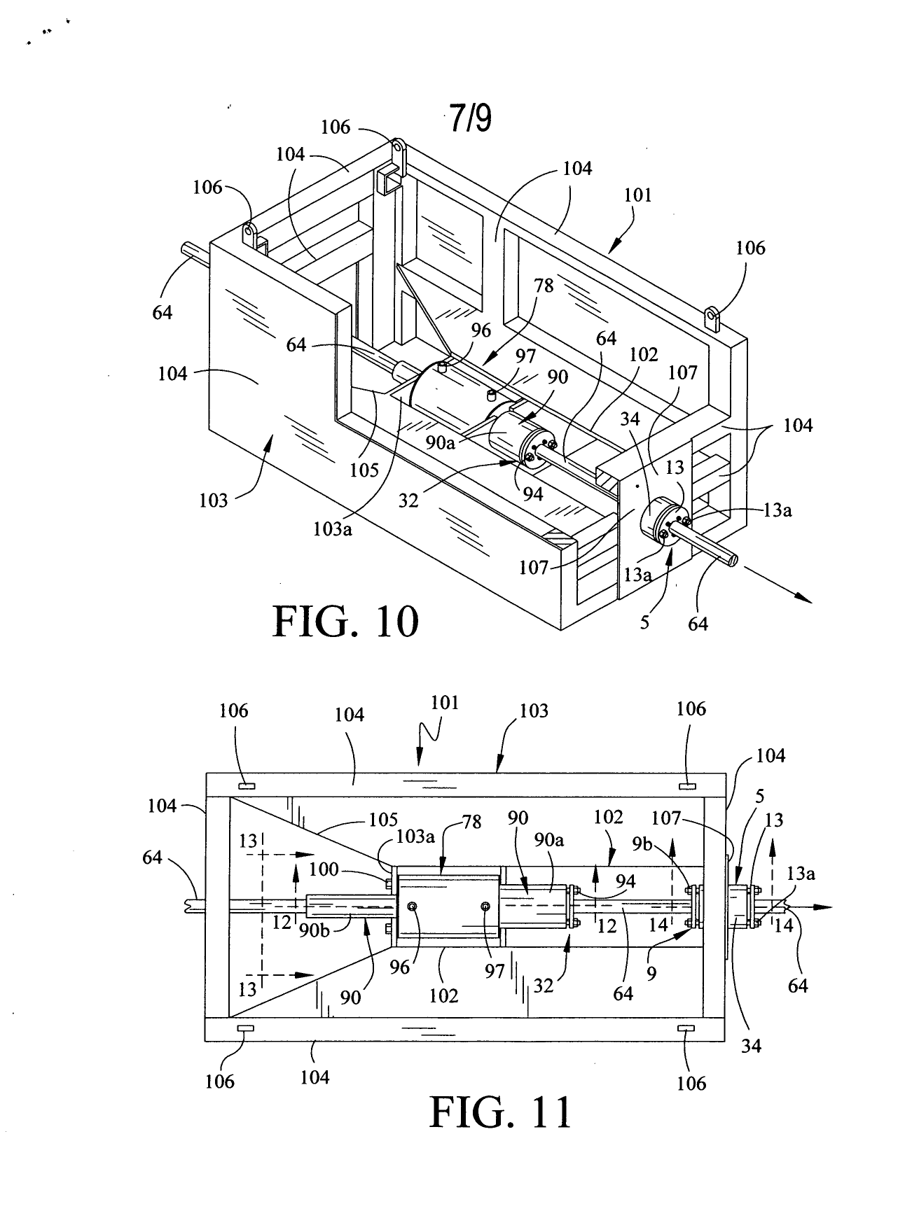

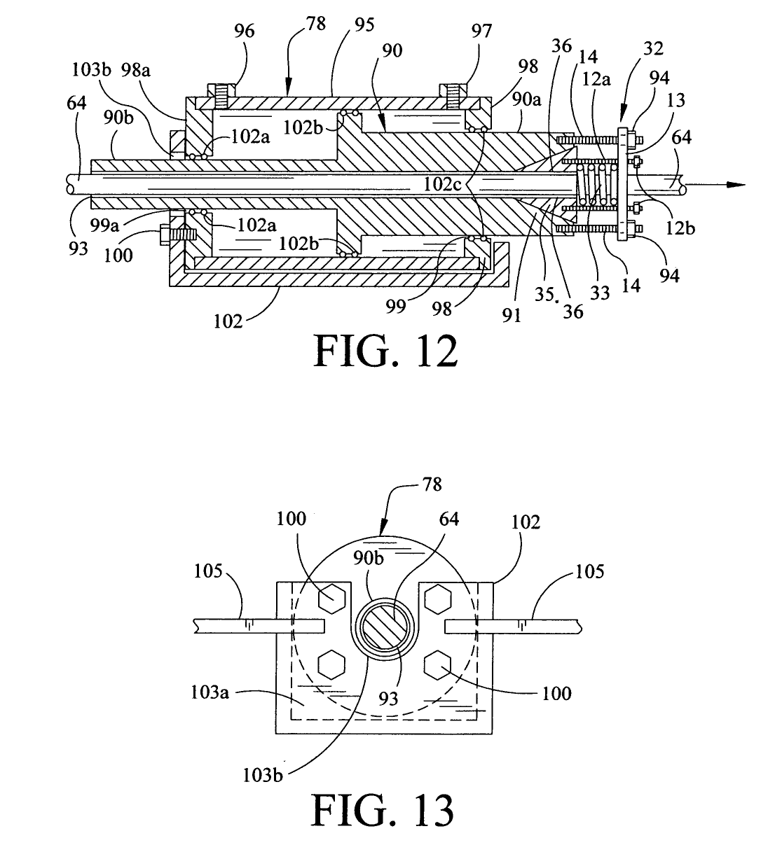

Referring now to FIGS. 10-13 of the drawings, while substantially any winch or alternative static pull apparatus can be used to operate the springless stored energy coupling 1, dual spring stored energy coupling 20, tri-spring stored energy coupling 30 and single-spring stored energy coupling 31 of this invention, in a preferred embodiment a hydraulic cylinder 78 is mounted in a cylinder mount frame 101 for that purpose. The hydraulic cylinder 78 is further characterized by a ram 90 having a large ram end 90a and a small ram end 90b, as illustrated in FIG. 12. The large ram end 90a of the ram 90 extends through the front cylinder opening 99 of a corresponding front cylinder end 98, which is typically bolted or otherwise attached to the cylinder housing or wall 95 of the hydraulic cylinder 78, while the small ram end 90b extends rearwardly of the hydraulic cylinder 78, through the rear cylinder end opening 99a of a rear cylinder end 98a. The pull rod 64 extends through a longitudinal ram bore 93 of the ram 90 and also through a cylinder gripping element 32, which is mounted on the large ram end 90a of the ram 90, as further illustrated in FIGS. 10-12. The ram 90 is typically sealed for reciprocation inside the corresponding cylinder wall 95 of the hydraulic cylinder 78 by O-rings 102a, 102b and 102c, as further illustrated in FIG. 12 of the drawings.

In a preferred embodiment of the invention and referring again to FIGS. 10-12 of the drawings, the hydraulic cylinder 78 is seated and mounted in a mount box 103 of the cylindrical mount frame 101 by means of a mount pad 102 and frame members 104, as well as a rear frame plate 105, which serve to securely retain the hydraulic cylinder 78 in place in the mount box 103. Lifting cleats 106 are typically provided on the top frame members 104 of the mount box 103 for handling the cylinder mount frame 101 and the enclosed hydraulic cylinder 78. As further illustrated in FIG. 13 of the drawings, the hydraulic cylinder 78 is securely mounted at the rear end thereof to a cradle plate 103a in a cradle plate slot 103b, by means of cylinder anchor bolts 100.

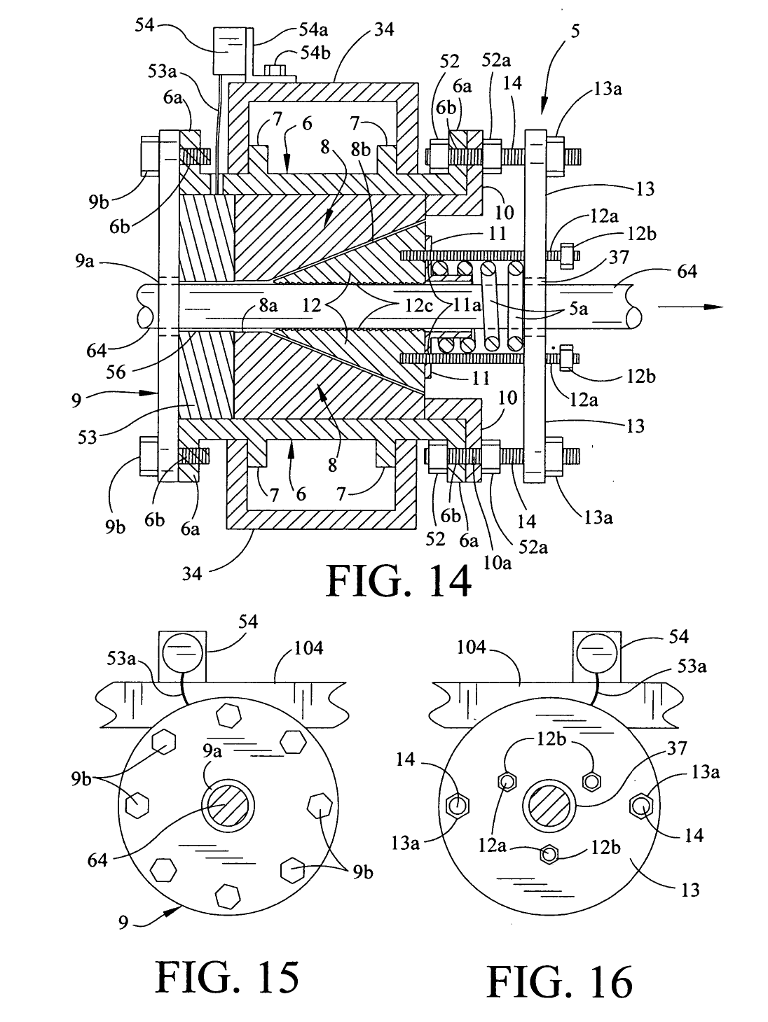

Referring again to FIGS. 10 and 11 and to FIGS. 14-16 of the drawings, a frame gripping element 5 is mounted on the front end of the cylinder mount frame 101 at the front ones of the frame members 104, in a gripping element mount flange 34 and on a front frame plate 107. As further illustrated in FIGS. 10 and 11 the frame gripping element 5 is positioned in linearly-aligned, spaced-apart relationship with respect to the cylinder gripping element 32, mounted on the large ram end 90a of the ram 90 and the pull rod 64 extends through the ram bore 93 of the ram 90 of the hydraulic cylinder 78, both rearwardly and forwardly through the cylinder gripping element 32 and the aligned frame gripping element 5, as illustrated.

As further illustrated in FIG. 14 of the drawings in a preferred embodiment of the invention the frame gripping element 5 is characterized by a frame gripping element housing 6, seated on the gripping element mount flange 34, the latter of which extends through the front frame plate 107 of the cylinder mount frame 101 (FIG. 11). The frame gripping element housing 6 is secured in place by a pair of spaced-apart housing stops 7, extending radially from the frame gripping element housing 6, as illustrated. A frame gripping element adaptor body 8 is seated in the frame gripping element housing 6 and the frame gripping element adaptor body 8 is characterized by a bevelled or cone-shaped frontal opening or body cone 8b, which slidably receives multiple (typically three) wedges 12, each having wedge teeth 12c that face the pull rod 64 as the pull rod 64 extends through the curved center portions of the wedges 12 at the wedge teeth 12c and through the adaptor body opening 8a in the frame gripping element adaptor body 8. In a preferred embodiment a wafer-shaped load cell 53 is seated on the rear end of the frame gripping element adaptor 8 and is provided with a central load cell opening 56 for receiving the pull rod 64. A blind flange 9 is seated on the load cell 53 and is provided with a blind flange opening 9a for also receiving the pull rod 64, to secure the load cell 53 tightly against the frame gripping element adaptor body 8. Blind flange bolts 9b extend through spaced-apart openings (not illustrated) in the periphery of the round blind flange 9 and are threaded into internally-threaded housing flange openings 6b of a round housing flange 6a, extending from the frame gripping element housing 6 to secure the blind flange 9 tightly in place and the load cell 53 securely against the frame gripping element body 8. On the opposite or front end of the frame gripping element 5, a frame gripping element spring 5a is disposed against an inside flange 11, which is seated against the respective wedges 12, with the opposite end of the frame gripping element spring 5a seated against a plate flange 13 that also receives the pull rod 64 through a central plate flange opening 37 therein. The plate flange 13 is maintained in an adjustable position against the frame gripping element spring 5a by a pair of parallel, spaced-apart and threaded rods 14, one end of each of which extends through aligned outside flange openings 10a in an outside flange 10 and in the housing flange openings 6b of the adjacent housing flange 6a of the frame gripping element housing 6. This end of the respective threaded rods 14 is secured in the housing flanges 6a by inside nuts 52 and middle nuts 52a are secured against the outside flange 10, respectively, to sandwich the outside flange 10 and connected housing flange 6a between the corresponding inside nuts 52 and middle nuts 52a, as illustrated. The opposite ends of the threaded rods 14 extend through corresponding openings (not illustrated) provided in the plate flange 13 and are each secured in place by a plate flange nut 13a.

Proper tensioning of the frame gripping element spring 5a and the wedges 12 inside the tapered or cone-shaped surface or body cone 8b of the frame gripping element adaptor body 8 is effected by means of three spaced-apart wedge rods 12a, each of which extends through a corresponding inside flange opening 11a in the inside flange 11 and is threadably seated in a corresponding one of each of the three wedges 12. The opposite ends of the wedge rods 12a, which extend through corresponding openings (not illustrated) provided in the plate flange 13, are secured in place by a corresponding wedge bolt nut 12b. Accordingly, manipulation of the wedge bolt nuts 12b in the clockwise and counterclockwise direction on the respective threaded rods 14 effects a desired degree of tension in the frame gripping element spring 5a as the plate flange 13 adjusts on the two threaded rods 14 between the corresponding plate flange nuts 13a and middle nuts 52a. This tension is applied to the respective wedges 12 to effect the desired force with which the wedge teeth 12c engage the pull rod 64 during operation of the hydraulic cylinder 78, as hereinafter further described.

As further illustrated in FIGS. 14-16 of the drawings, a load cell gauge 54 is mounted on a gauge mount flange 54a, which is bolted to the gripping element mount flange 34 by a gauge mount bolt 54b and the load cell gauge 54 is connected to the load cell 53 by load cell wiring 53a. Accordingly, the load cell 53 is fitted on the pull rod 64 at a load cell opening 56 and yet allows the pull rod 64 to move in the load cell opening 56 with respect to the load cell 53. The load on the pull rod 64, and thus the force applied to the replacement pipe 80 (illustrated in FIG. 1), which is typically high density polyethylene (HDPE) pipe, can thus be measured as the frame gripping element adapter body 8 slides in the frame gripping element housing 6 and compresses the load cell 53 when the ram 90 moves rearwardly in the hydraulic cylinder 78 (FIG. 12), to prevent overload and excessive stressing and stretching of the replacement pipe 80.

Referring again to FIGS. 1, 9, 10-12 and 14-16 of the drawings, under circumstances where the hydraulic cylinder 78 is coupled to the single-spring stored energy coupling 31 illustrated in FIG. 9 and the rod 64 extends through the ram bore 93 in the ram 90 of the hydraulic cylinder 78, the single-spring stored energy coupling 31 can be pulled through a pipe 83 to destroy the pipe 83 and extend a replacement pipe 80 therethrough, as follows. It will be appreciated by those skilled in the art that either a typically steel pull rod 64 can be used for the entire pulling operation or the pull rod 64 can be attached to a typically steel pull cable 40, as illustrated in FIG. 1, wherein the pull cable 40 is connected to the pull rod 64 extending through the ram 90 of the hydraulic cylinder 78 and a separate pull rod 64 segment is extended into the bursting head 43 of the single-spring stored energy coupling 31, as illustrated in FIG. 9. The pulling operation is commenced by initially extending the ram 90 rearwardly inside the cylinder wall 95 of the hydraulic cylinder 78, in the opposite direction from the arrow illustrated in FIG. 12 by operation of a suitable hydraulic cylinder operating system (not illustrated) known to those skilled in the art. Tension is then applied to the pull rod 64 and thus, the single-spring stored energy coupling 31, by forward movement of the hydraulic ram 90 due to introduction of hydraulic fluid into the cylinder power stroke port 96 under pressure, according to a typical hydraulic fluid cylinder operating system (not illustrated) for operating the hydraulic cylinder 78. The cylinder gripping element 32 operates in the same manner as the frame gripping element 5, as the cylinder gripping element wedge teeth 36 of the cylinder gripping element wedges 35, seated in the frontal cone-shape opening of the receiver 91 of the ram 90, thus engage the pull rod 64 and force the pull rod 64 forwardly in the direction of the arrow illustrated in FIG. 12, extending the bursting head 43 through the pipe 83, as illustrated in FIG. 9. The cylinder gripping element wedges 35 are typically three in number and are typically mounted in the cone-shaped opening in the receiver 91 against the tension in the cylinder gripping element spring 33, in the same manner as the corresponding wedge and spring assembly illustrated in FIG. 14 operate in the frame gripping element 5. This action of the ram 90 further compresses the first spring 68 in the coupling housing interior 3 of the coupling housing 2, as hereinafter described with respect to the respective stored energy couplings detailed herein. As the pull rod 64 extends forwardly in the direction of the arrow illustrated in FIG. 12, it freely extends through the respective wedges 12 in the frame gripping element adaptor body 8 of the frame gripping element 5, since the wedges 12 are moved in the body cone 8b against the tension in the frame gripping element spring 5a, thus releasing the wedge teeth 12c from engagement with the pull rod 64. When the ram 90 has reached its full stroke forwardly inside the cylinder wall 95 of the hydraulic cylinder 78 in the direction of the arrow in FIG. 12, it begins a rapid rearward stroke responsive to introduction of hydraulic fluid into the cylinder return stroke port 97 and exhausting hydraulic fluid from the cylinder wall power stroke port 96. This rapid reversal of the ram 90 operation occurs because the hydraulic fluid flowing into the cylinder return stroke port 97 rapidly fills the small cylinder volume between the large ram end 90a and the corresponding interior of the cylinder wall 95. Accordingly, the cylinder gripping element wedge teeth 36 in the cylinder gripping element 32 are momentarily released from engagement with the pull rod 64 in the cylinder gripping element 32, to facilitate free rearward movement of the entire ram 90 and the attached cylinder gripping element 32. However, the pull rod 64 is immobilized and does not move rearwardly with the reversing ram 90 because of the operation of the respective wedges 12 in the frame gripping element 5, the wedge teeth 12c of which tightly engage the pull rod 64 as the pull rod 64 tends to move rearwardly with the ram 90. This action exerts a compressive force on the frame gripping element adaptor body 8 and the load cell 53, allowing measurement of the tensile load on the pull rod 64 and the replacement pipe 80. The action also immobilizes the pull rod 64 until the ram 90 is re-positioned for another forward stroke, wherein the cylinder gripping element 32 re-engages the pull rod 64 and begins another incremental advancement of the pull rod 64 forwardly, through the now disengaged frame gripping element 5 in the direction of the arrow illustrated in FIG. 12, as detailed above. The pull rod 64 again moves freely through the frame gripping element 5 by release of the corresponding wedge teeth 12c from engagement with the pull rod 64. This alternative gripping and release action of the frame gripping element 5 and cylinder gripping element 32 responsive to operation of the hydraulic cylinder 78 is continued as described above until the single-spring stored energy coupling 31 has completed its movement through the pipe 83 to be broken and has moved the replacement pipe 80 into position where the bursting end 43 can be removed from the replacement pipe 80 by removing the corresponding pipe screws 81 from engagement with the housing end plate 4 and the replacement pipe 80, in conventional fashion.

In detailed operation of the stored energy coupling systems described above during operation of the hydraulic cylinder 78 as described above and referring again to FIGS. 1-8 of the drawings, the hydraulic cylinder 78 and the associated cylinder mount frame 101 are typically situated in a manhole or excavation (not illustrated) at an open end of the underground gas, water, sewer or other utility pipe 83 (illustrated in phantom in FIGS. 1, 4.1 and 8 of the drawings) to be burst and replaced. A pull cable 40 or pull rod 64 is then extended through the pipe 83 to be replaced and one end of the pull cable 40 or pull rod 64 is extended through the hydraulic cylinder 78 pulling apparatus, including the frame gripping element 5 and the cylinder gripping element 32 and the other end attached to either the bursting head 43 as illustrated in FIGS. 1-3 and 7 of the drawings, or directly to a springless stored energy coupling 1, a dual spring stored energy coupling 20, a tri-spring stored energy coupling 30 or a single-spring stored energy coupling 31, in the manner illustrated in FIGS. 4.1, 5, 6, 8 and 9, respectively, of the drawings. Under circumstances where pipe valves, concrete encasements, timbers and/or other major obstructions are likely to be encountered by the bursting head 43 in the pipe 83, a pneumatic or hydraulic hammer 86 is typically mounted in connection with the springless stored energy coupling 1, dual spring stored energy coupling 20, tri-spring stored energy coupling 30 or single-spring stored energy coupling 31, as heretofore described and illustrated. A replacement pipe 80 is also typically attached to the expander 44 or the housing end plate 4 of the bursting head 43, for pulling in place responsive to breaking of the old pipe 83. Tension is then applied to the pull cable 40 and/or the pull rod 64 until the pipe cutting blades 47, located on the bursting head 43, engage the end of a pipe 83 to be burst. The rod or cable pulling device and typically the hydraulic cylinder 78, is then operated in the manner described above to continually draw the bursting head 43, including the expander 44 and the replacement pipe 80, as well as the enclosed or connected hammer 86, through the pipe 83 tunnel as the ram 90 reciprocates in the hydraulic cylinder 78 and the frame gripping element 5 and cylinder gripping element 32 alternately grip the pull cable 40 or pull rod 64 as the pipe 83 is thus destroyed by operation of the pipe cutting blades 47.

Referring again to FIGS. 1 and 5-7 of the drawings, by way of example, this tension applied to the pull cable 40 and/or the pull rod 64 in the dual spring stored energy coupling 20 draws the rod plate 65 forwardly and compresses the second spring 68a against the corresponding spring plate 70, limited by the second spring stop 71a, in the dual spring stored energy coupling 20, as illustrated in FIG. 7. Additional tension applied to the pull cable 40 and/or the pull rod 64 compresses the first spring 68 against the housing end plate 4, limited by the first spring stop 71. Consequently, the first spring 68 and the second spring 68a tend to bias the dual spring stored energy coupling 20 forwardly by exerting forward pressure against the removable forward housing end plate 4. This action further biases the pipe cutting blades 47 of the bursting head 43 against the pipe 83, as illustrated in FIG. 1. As the pipe cutting blades 47 engage the pipe 83, the tapered design and shape of the pipe cutting blades 47 facilitate cutting of the pipe 83 at radially spaced-apart intervals as the bursting head 43 is pulled progressively along the pipe 83. Simultaneously, the replacement pipe 80 is drawn into place in the pipe 83 tunnel or path behind the pipe bursting head 43 until the bursting head 43 reaches the opposite end of the pipe 83 at or near the hydraulic cylinder 78 (FIGS. 10 and 11) or an alternative pulling device (not illustrated) and the entire length of the pipe 83 has been burst and the replacement pipe 80 drawn into its place.

As further illustrated in FIGS. 5-8 of the drawings, under circumstances where the pipe cutting blades 47 of the bursting head 43 encounter a significant obstruction or obstructions in the pipe 83, such as valves and the like (not illustrated), the hammer 86 can be pneumatically or hydraulically operated to repetitively withdraw the hammer striker 87 from engagement with the hammer seat located inside the hammer housing 60 and strike the hammer housing 60, in rapid succession. Each time the hammer striker 87 strikes the corresponding forward inner portion of the hammer housing 60, the bursting head 43 is transiently driven forwardly with respect to the rod plate 65 and the bursting head 43 is pushed forwardly against the pipe 83 at the pipe cutting blades 47. Simultaneously, the first spring 68 and the second spring 68a (and in the case of the FIG. 8 embodiment, the third spring 68b) are normally compressed between the rod plate 65 and the removable forward housing end plate 4, as the rod plate 65 is pulled forwardly, to increase the distance between the rear housing end plate 4 and the rod plate 65. Consequently, each hammer blow momentarily forces the dual spring stored energy coupling 20 and the tri-spring stored energy coupling 30, respectively, forwardly and the correspondingly released first spring 68 and second spring 68a (as well as the third spring 68b) exert a transient forward force against the forward housing end plate 4 as the hammer striker 87 strikes the internal frontal portion of the hammer housing 60. Accordingly, the first spring 68 and second spring 68a, as well as the third spring 68b, augment the driving effect of the pipe cutting blades 47 against the pipe 83. The substantially constant or intermittent pulling tension of the hydraulic cylinder 78 or a conventional rod pulling device (not illustrated) on the pull cable 40 or the pull rod 64, as the case may be and on the respective stored energy couplings, combined with the intermittent pounding action of the hammer 86, which is augmented by the energy in the first spring 68 (FIG. 9), the first spring 68 and the second spring 68a (FIGS. 2, 3 and 5-7), and the first spring 68, second spring 68a and the third spring 68b (FIG. 8), causes the bursting head 43 to progressively cut and burst the pipe 83 and cut through the obstructions in the pipe 83 with increased efficiency as the bursting head 43 migrates along the pipe 83 and draws the replacement pipe 80 into position.

It will be appreciated by those skilled in the art that the various embodiments of the stored energy couplings of this invention, whether incorporated together in a common spring assembly and hammer housing 66 as illustrated in FIGS. 1-3, or without a spring or springs as illustrated in FIGS. 4 and 4.1 or with one or more springs as illustrated in FIGS. 5-9, operate to not only protect the static pulling apparatus, but also to augment the hammer 86 in increasing the efficiency of the bursting head 43. Moreover, it will be appreciated that the composite stored energy coupling and hammer (FIGS. 1-3), the springless stored energy coupling 1, the dual spring stored energy coupling 20, the tri-spring stored energy coupling 30 and the single-spring stored energy stored energy coupling 31, in all of the disclosed variations, may be coupled to the rear or the front of the bursting head 43, as long as the respective stored energy coupling is located forwardly of the hammer 86. It will further be understood that any number of springs having selected identical or different coil strengths and compression rates may be utilized in the stored energy couplings of this invention, depending upon the desired pipe bursting application.

Referring again to FIGS. 7-9 of the drawings, it will be appreciated by those skilled in the art that one or more resilient, compressible bias mechanisms such as one or more rubber or plastic plug or plugs and a corrugated plastic plug (not illustrated) in particular, can be substituted for the first spring 68, second spring 68a and/or the third spring 68b, respectively, for tensioning the pull rod 64, which extends longitudinally through these plugs. The rubber or plastic plugs thus serve to effect a rebound action in the respective coupling housing, as described herein with respect to the corresponding springs.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A stored energy coupling for connecting a pulling apparatus to a hammer and a pipe-bursting head, comprising a coupling housing engaging the hammer for selective striking by the hammer; a rod having one end slidably disposed in one end of said coupling housing; and a rod plate carried by said one end of said rod and the opposite end of said rod from said one end connected to the pulling apparatus, wherein said rod plate and said rod are slidably displaced in said housing responsive to striking of said coupling housing by the hammer.

2. The stored energy coupling of claim 1 wherein said hammer is disposed inside said coupling housing and comprising a striker plate fixed in said coupling housing for striking by said hammer and at least one bias mechanism provided on said rod inside said coupling housing, said bias mechanism interposed between said rod plate and said one end of said coupling housing for tensioning said rod responsive to operation of the pulling apparatus and advancing said pipe-bursting head toward the pulling apparatus responsive to said striking of said striker plate by the hammer.

3. The stored energy coupling of claim 1 wherein said pipe bursting head is provided on said coupling housing and the hammer is disposed in said coupling housing opposite said rod plate and comprising a striker plate fixedly disposed in said coupling housing between the hammer and said rod plate for said selective striking by the hammer.

4. The stored energy coupling of claim 3 comprising at least one spring provided on said rod inside said coupling housing, said at least one spring interposed between said rod plate and said one end of said coupling housing for tensioning said rod responsive to operation of the pulling apparatus and advancing said pipe-bursting head toward the pulling apparatus responsive to said selective striking by the hammer.

5. The stored energy coupling of claim 2 wherein said bias mechanism comprises a plurality of springs disposed on said rod in said coupling housing between said rod plate and said one end of said coupling housing.

6. The stored energy coupling of claim 1 wherein the hammer is disposed in the opposite end of said coupling housing from said one end and opposite said rod plate and comprising a striker plate fixed in said coupling housing between said rod plate and the hammer for said selective striking by the hammer and at least one spring provided on said rod inside said coupling housing, said spring interposed between said rod plate and said one end of said coupling housing for tensioning said rod responsive to operation of the pulling apparatus and advancing said pipe-bursting head toward the pulling apparatus responsive to said operation of the hammer.

7. The stored energy coupling of claim 6 comprising a cable having one end connected to the opposite end of said rod from said one end and the opposite end of said cable attached to the pulling apparatus.

8. The stored energy coupling of claim 7 wherein said pipe bursting head is provided on said coupling housing forwardly of the hammer.

9. The stored energy coupling of claim 1 wherein the hammer is disposed in said coupling housing opposite said rod plate and said pipe bursting head is located on said coupling housing forwardly of the hammer and comprising a striker plate fixed in said coupling housing between said rod plate and the hammer for striking by the hammer and a plurality of springs of selected spring tension provided on said rod inside said coupling housing, said springs interposed between said rod plate and said one end of said coupling housing for tensioning said rod responsive to operation of the pulling apparatus and advancing said pipe-bursting head toward the pulling apparatus responsive to said operation of the hammer.

10. A stored energy coupling for connecting a pipe-bursting head and a hammer to a pulling apparatus comprising a coupling housing carrying the hammer, said coupling housing connected to the pipe-bursting head; a rod having one end slidably disposed in one end of said coupling housing and a rod plate carried by said one end of said rod, said rod plate disposed in spaced-apart relationship with respect to the hammer and the opposite end of said rod connected to the pulling apparatus; and a striker plate fixed in said coupling housing between the hammer and said rod plate, wherein said rod plate moves toward the hammer in said coupling housing responsive to striking of said striker plate by the hammer against the tension applied to the rod by the pulling apparatus, for insulating the pulling apparatus from stress by said striking of the striker plate by the hammer.

11. The stored energy coupling of claim 10 comprising at least one bias mechanism provided in said coupling housing between said rod plate and said one end of said coupling housing for augmenting said tension applied to said rod responsive to said striking of said striker plate by the hammer and advancing of said pipe bursting head toward the pulling apparatus.

12. The stored energy coupling of claim 11 wherein said at least one bias mechanism comprises at least one spring provided in said coupling housing between said rod plate and said one end of said coupling housing.

13. A stored energy coupling for a pipe bursting apparatus, comprising a coupling housing; a pipe bursting head carried by said coupling housing; a pulling apparatus spaced-apart from said pipe bursting head; an elongated pulling member having one end connected to said pulling apparatus and the opposite end of said pulling member extending through said pipe bursting head and into one end of said coupling housing; a rod plate terminating said opposite end of said pulling member; at least one spring disposed on said pulling member between said rod plate and said one end of said coupling housing; a hammer disposed in said coupling housing in spaced-apart relationship with respect to said rod plate; and a striker plate fixedly provided in said coupling housing between said rod plate and said hammer, wherein tensioning of said pulling member by operation of said pulling apparatus compresses said spring and striking of said striker plate by said hammer intermittently decompresses said spring for augmenting advancement of said pipe bursting head toward said pulling apparatus.

14. The stored energy coupling of claim 13 wherein said at least one spring comprises a plurality of springs provided in said coupling housing on said pulling member between said rod plate and said one end of said coupling housing.

15. The stored energy coupling of claim 13 wherein said pulling member comprises a steel rod.

16. The stored energy coupling of claim 15 wherein said at least one spring comprises a plurality of springs of selected tension provided in said coupling housing on said pulling member between said rod plate and said one end of said coupling housing.

17. The stored energy coupling of claim 13 wherein said pulling member comprises a steel cable.

18. The stored energy coupling of claim 17 wherein said at least one spring comprises a plurality of springs of selected tension provided in said coupling housing on said pulling member between said rod plate and said one end of said coupling housing.

19. An apparatus for bursting a pipe comprising a pipe bursting mechanism for engaging the pipe; a stored energy coupling engaging said pipe bursting mechanism; a hammer engaging said stored energy coupling rearwardly of said pipe bursting mechanism for selectively striking said stored energy coupling; a pulling member having one end engaging said pipe bursting mechanism for pulling said pipe bursting mechanism against the pipe; a hydraulic cylinder spaced-apart from said pipe bursting mechanism and a frame carrying said hydraulic cylinder; a piston or ram disposed in reciprocating relationship in said hydraulic cylinder and a pulling member-gripping element carried by said piston or ram, said pulling member gripping element alternately gripping and releasing the opposite end of said pulling member from said one end; and a frame gripping element carried by said frame in spaced-apart, substantially linearly-aligned relationship with respect to said pulling member gripping element, for alternately gripping and releasing said pulling member, wherein said pipe bursting mechanism progressively cuts and bursts the pipe along the length of the pipe as said piston or ram advances in said hydraulic cylinder, said pulling member pulls said pipe bursting mechanism against the pipe and said hammer strikes said stored energy coupling, responsive to alternate gripping of said pulling member by said pulley member gripping element and said frame gripping element.

20. The apparatus of claim 19 wherein said pipe bursting mechanism comprises a pipe bursting head for engaging the pipe and a bias mechanism provided in said stored energy coupling for engaging said pulling member and biasing said stored energy coupling and said pipe bursting head against the pipe as said piston or ram in said hydraulic cylinder applies tension to said pulling member.

21. The apparatus of claim 20 wherein said pulling member comprises a steel rod.

22. The apparatus of claim 20 wherein said pulling member comprises a steel cable.

23. An apparatus for pulling a workload comprising a pulling member for connection to the workload; a hydraulic cylinder disposed in spaced-apart relationship with respect to the workload and a frame mounting said hydraulic cylinder; a ram disposed for reciprocation in said hydraulic cylinder; a first gripping element carried by said ram and a first set of wedges adjustably provided in said first gripping element for selectively gripping said pulling member; a first spring adjustably engaging said first set of wedges for adjusting the grip of said first set of wedges on said pulling member; a second gripping element carried by said frame, said second gripping element disposed in substantially linearly-aligned, spaced-apart relationship with respect to said first gripping element; an adaptor body carried by said second gripping element and a body cone provided in said adaptor body; a second set of wedges adjustably seated in said body cone for selectively gripping said pulling member; and a second spring adjustably engaging said second set of wedges for adjusting the grip of said second set of wedges on said pulling member, wherein the workload is advanced toward said hydraulic cylinder responsive to reciprocation of said ram and alternate gripping of said pulling member by said first set of wedges in said first gripping element and said second set of wedges in said second gripping element.

24. The apparatus of claim 23 wherein said ram is characterized by a large ram end carrying said first gripping element and a small ram end extending from said large ram end, wherein said ram rapidly reciprocates rearwardly on said pulling member as said first set of wedges releases said grip on said pulling member and said second set of wedges grips said pulling member.

25. The apparatus of claim 24 wherein said pulling member comprises a steel rod.

26. The apparatus of claim 24 wherein said pulling member comprises a steel cable.

27. The apparatus of claim 23 comprising a load cell provided in said second gripping element and engaging said adaptor body for determining the tension in said pulling member responsive to said gripping of said pulling member by said second set of wedges in said second gripping element.

28. The apparatus of claim 27 wherein said ram is characterized by a large ram end carrying said first gripping element and a small ram end extending from said large ram end, wherein said ram rapidly reciprocates rearwardly on said pulling member as said first set of wedges releases said grip on said pulling member and said second set of wedges grips said pulling member.

29. An apparatus for pulling a workload comprising a pulling member for connection to the workload; a hydraulic cylinder disposed in spaced-apart relationship with respect to the workload and a frame mounting said hydraulic cylinder; a ram disposed for reciprocation in said hydraulic cylinder; a first gripping element carried by said ram and a first set of wedges adjustably provided in said first gripping element for engaging said pulling member; a first spring adjustably engaging said first set of wedges for adjusting the grip of said first set of wedges on said pulling member; a second gripping element carried by said frame, said second gripping element disposed in substantially linearly-aligned, spaced-apart relationship with respect to said first gripping element; an adaptor body carried by said second gripping element and a body cone provided in said adaptor body; a second set of wedges adjustably seated in said body cone for engaging and selectively gripping said pulling member; a second spring adjustably engaging said second set of wedges for adjusting the grip of said second set of wedges on said pulling member; and a load cell provided in said second gripping element and engaging said adaptor body for determining the tension in said pulling member responsive to said gripping of said pulling member by said second set of wedges in said second gripping element, wherein the workload is advanced toward said hydraulic cylinder responsive to reciprocation of said ram and alternate gripping of said pulling member by said first set of wedges in said first gripping element and said second set of wedges in said second gripping element.

30. A method for connecting a pipe bursting head to a hydraulic cylinder pulling apparatus by a pulling member extending between the pipe bursting head and the hydraulic cylinder pulling apparatus comprising the step of interposing a stored energy coupling between the pulling member and the pipe bursting head.

31. The method according to claim 30 comprising the step of providing at least one bias mechanism in the stored energy coupling and engaging the bias mechanism with the pulling member for applying tension on the pulling member.

32. A method for bursting existing pipe and pulling new pipe underground comprising providing a hydraulic cylinder having a reciprocating ram and a first gripping element on one end of the reciprocating ram; mounting the hydraulic cylinder in a frame; providing a second gripping element in the frame, the second gripping element disposed in spaced-apart, substantially linearly aligned relationship with respect to the first gripping element; positioning a pipe-bursting apparatus against the existing pipe; connecting one end of a pulling member to the pipe bursting apparatus and extending the opposite end of the pulling member through the existing pipe and through the first gripping element and the second gripping element, and bursting the existing pipe and pulling the new pipe in the location of the existing pipe responsive to reciprocation of the ram in the hydraulic cylinder and alternate gripping of the pulling member by the first gripping element and the second gripping element.

33. The method according to claim 32 comprising the step of providing a load cell in the second gripping element for determining the tension in the pulling member when the pulling member is gripped by the second gripping element.
